(19) United States
(12) Patent Application Publication
(10) Pub. No.: US 2006/0245547 A1
(43) Pub. Date: Nov. 2, 2006

(54) Increased detectability and range for x-ray backscatter imaging systems

(76) Inventors: Joseph Callerame, Waltham, MA (US); Richard Mastronardi, Medfield, MA (US)

Correspondence Address: BROMBERG & SUNSTEIN LLP, 125 SUMMER STREET, BOSTON, MA, 02110-1618, US

(21) Appl. No.: 11/386,033

(22) Filed: Mar. 21, 2006

Related U.S. Application Data
(60) Provisional application No. 60/664,278, filed on Mar. 21, 2005.

(51) Int. Cl. G01N 23/201; G21K 1/04

(52) U.S. Cl. 378/160; 378/87

(57) ABSTRACT

An inspection system based on penetrating radiation provides an option to significantly narrow the field of view of a scan. First and second primary limiting apertures are provided for interposition between a source of penetrating radiation and an inspected object. This allows for significantly increasing the flux of penetrating radiation on this narrowed region of interest, thereby advantageously improving detectability. Alternatively or in addition, an operator can use the higher flux to increase the distance from which an object can be imaged. Embodiments include both scatter and transmission systems that employ a pencil beam.

The present application claims priority from U.S. Provisional Application Ser. No. 60/664,278, filed Mar. 21, 2005, which application is incorporated herein by reference.

### FIELD OF THE INVENTION

The present invention relates generally to x-ray imaging systems such as backscatter imaging systems, and specifically to controlling the sensitivity and range of such systems as a function of the flux incident during inspection of specified portions of an inspected object.

### BACKGROUND ART

Current x-ray imaging systems typically make use of a relatively wide angle fan beam exiting an x-ray generator, typically an x-ray tube, formed, in some cases, into a scanning pencil beam by means of a chopper wheel, or otherwise. One such inspection system is depicted in FIG. 1. From the wide-angle radiation source, a continuously moving collimator, usually in the form of a rotating wheel with appropriately placed apertures, sequentially selects a small portion of this fan beam at each instant of time, scanning the object under inspection with a collimated beam whose position as a function of time is accurately known. Thus, point by point, a one-dimensional backscatter image is created by collecting backscattered radiation from each irradiated pixel for each collimator scan cycle. While the x-ray beam is scanning, either the object under inspection or the x-ray source and collimator moves in a direction orthogonal to the beam scan direction thereby creating a two dimensional image of the object.

In typical current practice, the angular coverage of the x-ray beam is determined by the angular extent of the x-ray beam as it exits the x-ray generator, in combination with any subsequent collimating structure. For example, a subsystem that may pick off a pencil-shaped portion of a fan beam produced by the x-ray generator and direct this pencil beam toward the object under inspection, scanning it, point by point, typically in a vertical direction. “Pencil-shaped,” as used herein, refers to a beam having any cross-sectional shape, the extent of each dimension of the cross-section, transverse to the beam propagation direction, being comparable, though not necessarily equal. For example, a tube with a 60 degree wide x-ray beam is able to subtend a maximum angle of 60 degrees. Thus, at a distance of 8 feet away from the tube focal spot, the beam is able to scan an object that is approximately 14 feet high. Moving the object farther away enables taller objects to be completely covered, although the increased distance leads to lower x-ray flux. “Flux,” as used herein and in any appended claims, refers to either the number or total power of x-ray photons crossing a unit cross-sectional area in a unit of time.

### SUMMARY OF THE INVENTION

Embodiments of the present invention are directed to inspection systems designed for inspecting an object, where the object of inspection may include a person. Preferred embodiments of the invention have a source of penetrating radiation that emits penetrating radiation and at least two primary limiting apertures: a first primary limiting aperture for defining a first field of view of the emitted penetration radiation, and a second primary limiting aperture for defining a second field of view of the emitted penetrating radiation. A spatial modulator forms the emitted penetrating radiation into a beam for irradiating the object with a scanning profile. A mechanism is provided for interposing one of the limiting apertures between the source and the spatial modulator, either on a fixed or contingent mode. In the contingent mode, one primary limiting aperture is used under a first set of conditions and a second primary limiting aperture is used under a second set of conditions.

In further such embodiments, the source of penetrating radiation may be contained within a conveyance that may be a vehicle capable of road travel or may be towed by another vehicle.

In various embodiments, the source of penetrating radiation may be an x-ray tube. Alternatively, the source of radiation may be a radioactive source. The spatial modulator may include one or more rotating chopper wheels.

### BRIEF DESCRIPTION OF THE DRAWINGS

FIG. 1 illustrates the basic principles of a backscatter beam forming and imaging system with a field of view large enough to cover a vehicle, for example.

FIG. 2 shows a backscatter beam-forming system designed for a more limited field-of-view, with increased detectivity over this more limited field-of-view, or alternatively, to increase system range, in accordance with preferred embodiments of the present invention.

### DETAILED DESCRIPTION OF SPECIFIC EMBODIMENTS

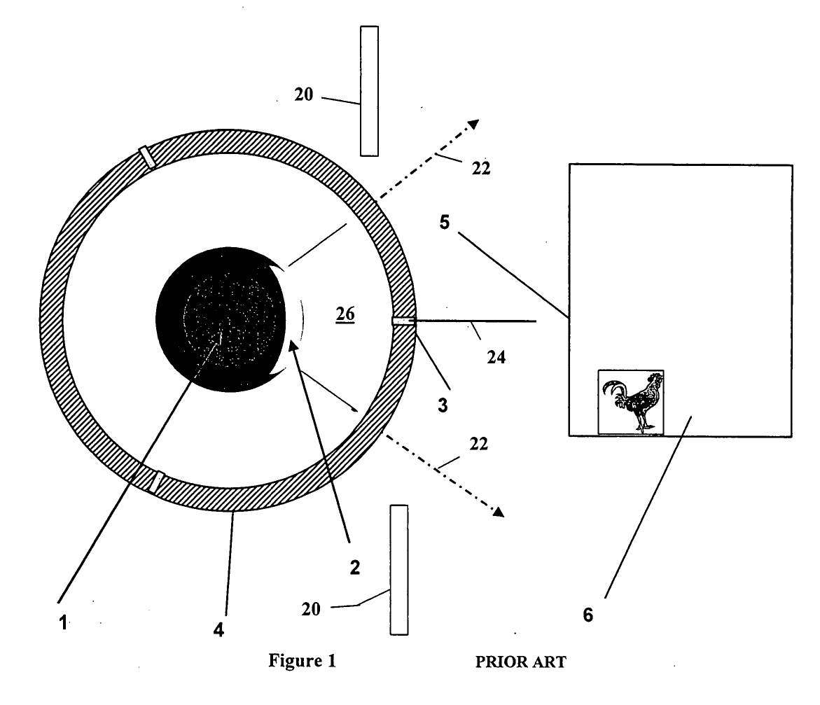

A description of embodiments of the present invention begins by reference to FIG. 1, where the main components of a prior art backscatter, or Compton scatter-based, imaging system are depicted schematically. X-ray scatter detectors 20 are preferrably large, limited only by the size of the conveyance in which the x-ray source is placed. A source of penetrating radiation, that may be an x-ray tube 1, for example, has a primary collimating aperture 2. X-ray tube 1 and primary collimating aperture 2 are disposed in the interior portion, not necessarily in the center, of a moving collimator 4 or other spatial modulator. The penetrating radiation is described herein as x-ray radiation, however the use of other penetrating radiation, such as gamma radiation, is within the scope of the present invention. Spatial modulator 4 may be a wheel, with a series of collimating moving apertures 3. As the wheel rotates, or alternative moving collimator causes the propagation direction of the penetrating radiation to vary, different portions 24 of an x-ray beam 26 exiting the primary collimator are allowed to pass through the moving apertures 3, effectively scanning the x-ray beam in one dimension, and subtending a total field of view limited by primary collimating aperture 2. Limits of the total field of view are designated by dashed lines 22.

Simultaneously with the scanning of exiting x-ray beam 24, either the entire x-ray system, with or without its detectors 20, is moved in a direction transverse to the beam scan direction, or the object under inspection 5 is itself moving past the x-ray system. The combination of the x-ray beam motion and the moving of either the source, or of the object, or both, gives rise to a two dimensional image 6 (represented by an image of a rooster) of the object under inspection.

Preferred embodiments of the present invention provide an operator of the inspection equipment with an option to reduce the field of view at a given object distance. At the same time the x-ray flux is increased within this smaller field of view. Because of the increased flux, detectability of potential objects of interest may be improved in the selected reduced field of view. Such embodiments may be particularly useful when an operator would like to further investigate a potential object of interest that may be poorly defined due to an x-ray flux level which renders a potential object of interest barely visible.

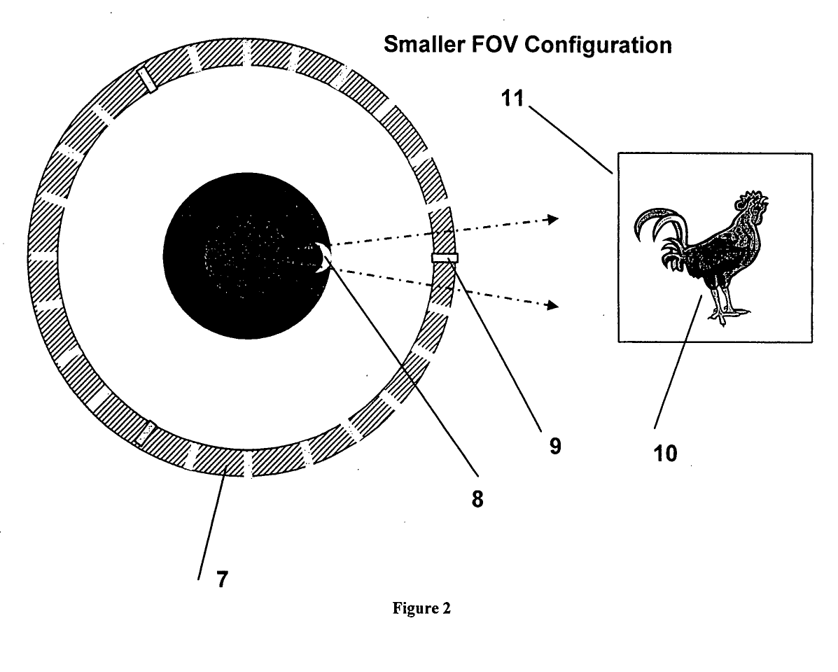

FIG. 2 illustrates principles underlying embodiments of the present invention. Here, an alternative beam forming system is used, when compared with the system depicted in FIG. 1. An x-ray tube 1 and detection subsystem 20 as used in current systems may continue to be used. However, primary collimator 8 has further restricted the range of exit angles from the x-ray tube. Furthermore, alternative chopper wheel 7 has a larger number of moving apertures 9, with the number of these apertures increased in rough proportion to the decreased range of the primary x-ray collimator. The net effect of these changes is to both restrict the field of view of the x-ray beam's scan 11, as well as to proportionately increase the number of times the x-ray beam traverses a given region of the object, assuming the relative transverse motion of the object is slow in comparison to the beam rotation velocity. Thus, a greater flux of penetrating radiation may be provided to the specific part of the object 10 on which the operator wishes to concentrate.

The operator may, while pointing a cursor at the full field-of-view (“FOV”) image, click on the center of the portion he would like to enhance, and re-institute another scan. The new scan has a much smaller angular FOV and an x-ray flux that is higher than the original scan by approximately the same factor by which the angular FOV was reduced. For example, if a first scan subtended an angle of 60 degrees, the second reduced-FOV, or zoomed scan may subtend an angle of 6 degrees centered on a particular portion of the object. The x-ray flux may also be increased by a factor of ten times over this reduced FOV, thereby leading to higher detectability. Reduction of the FOV to less than 10 degrees constitutes a “Zoom Mode” for purposes of the present invention. For an object at a fixed distance from the x-ray source, the pixel size, and thus the perceived resolution, would be unchanged. Alternatively, the chopper wheel aperture size could be changed for improved resolution.

In order to overcome the problem of degraded resolution with increasing range, it is desirable, in certain applications, to employ tighter collimation. Tighter collimation, however, may ultimately require a smaller focal spot size source. In accordance with alternate embodiments of the invention, operation in a mode of reduced field-of-view employs a source of relatively small focal spot size, such as provided, for example, in rotating-anode x-ray tubes.

In another embodiment of the invention, the use of a smaller angular field of view, together with the higher flux inherent from the improved zoom technique, may be used to extend significantly the range from which objects of interest can be detected. But the pencil beam emerging from the moving collimator is continually expanding and the backscatter detectors must be sufficiently large to capture as much backscattered radiation as possible. As a result, system resolution degrades as distance from source to object is increased. Therefore, although the use of the zoom feature will increase range by increasing beam flux on target, resolution will be degraded to some extent. This can be compensated for by reducing the aperture size that defines the incident pencil beam. But this will also reduce flux, and thus there are tradeoffs between the flux gain from the reduced field of view and the flux reduction that would result from narrowing the aperture that defines the pencil beam. However, generally speaking, pencil beam sizes that are of the order of as much as one inch in diameter, or one inch square, will provide adequate resolution for the threats envisioned. This implies that, in almost all circumstances, the flux gain resulting form incorporating the zoom feature will overwhelm any flux reduction required to keep resolution reasonable, at distances up to 100 feet or so.

The scanning technique described above requires two separate scans by the operator, one under “normal” flux and field-of-view conditions, and another under zoom conditions that would require a change in the collimating aperture geometry. In yet another embodiment, a single scan system may always be in zoom mode. In other words, it may be elected to use such a system with a single aperture geometry always set to a particular scan configuration that employs a narrow FOV. Such a system may be designed to be used for either more detailed inspection of smaller objects within the same range as current systems, or, alternatively, as a system capable of longer range scanning, with a range of up to 100 feet. A system such as this, if designed for longer range scanning, may employ an x-ray tube with substantially more power, or higher voltage, or both, than is currently used for backscatter scanning.

It is to be understood that the system described in the foregoing discussion may be fixed in position, or, alternatively, may be carried in a vehicle and may be operated during the course of travel of the vehicle. Operation of an x-ray inspection system under these conditions has been described in patent applications filed by American Science and Engineering, Inc.

Although the invention has been described in detail in terms of various exemplary embodiments, it should be apparent to those skilled in the art that various changes and modifications can be made, such as the application of the above teachings in the context of transmission- or sidescatter-based inspection, all of which modifications will achieve some of the advantages of the invention without departing from the true scope of the invention.

What is claimed is:

1. An inspection system designed for inspecting an object and capable of operation in a zoom mode, the system comprising:
a source of penetrating radiation;
a first primary limiting aperture for defining a first field of view of the emitted penetration radiation;
a second primary limiting aperture for defining a second field of view of the emitted penetrating radiation;
a spatial modulator for forming the emitted penetrating radiation into a beam for irradiating the object with a scanning profile; and
a mechanism for allowing election of interposition between the source of penetrating radiation and the spatial modulator of a specified one of the first primary limiting aperture and the second primary limiting aperture.

2. An inspection system in accordance with claim 1, wherein the mechanism for allowing election of interposing a first primary limiting aperture and a second limiting permits fixed operation in a zoom mode.

3. An inspection system in accordance with claim 1, wherein the mechanism for allowing election of interposing a first primary limiting aperture and a second limiting aperture includes a controller for interposing the first primary limiting aperture between the source and the object under a first set of conditions and the second primary limiting aperture under a second set of conditions.

4. An inspection system according to claim 1, wherein the source of penetrating radiation is contained within a conveyance.

5. An inspection system according to claim 1, wherein the source of penetrating radiation is an x-ray tube.

6. An inspection system according to claim 1, wherein the first primary limiting aperture has a field of view less than 10 degrees in at least one dimension.

7. An inspection system according to claim 1, wherein the spatial modulator includes a chopper wheel.

8. An inspection system according to claim 1, wherein the mechanism for allowing election includes an operator input.

9. An inspection system according to claim 1, further including a detector for detecting the penetrating radiation after interaction with the object.

10. An inspection system according to claim 9, wherein the detector is a scatter detector.

11. An inspection system according to claim 9, wherein the detector is a transmission detector.

12. A method for inspecting an object and capable of operation in a zoom mode, the method comprising:
providing a source of penetrating radiation;
electing one of at least two primary limiting apertures for defining a field of view of the emitted penetration radiation;
interposing the chosen one of the at least two primary limiting apertures between the source of penetrating radiation and a spatial modulator;
scanning the spatial modulator to form the emitted penetrating radiation into a beam for irradiating the object.

13. A method in accordance with claim 12, wherein the step of electing one of at least two primary limiting apertures includes electing a primary limiting aperture on a contingent basis during the course of operation.
